(19) United States
(12) Patent Application Publication
(10) Pub. No.: US 2002/0148390 A1
(43) Pub. Date: Oct. 17, 2002

(54) Pigment preparation for anticorrosion paints

(75) Inventor: Ralf Glausch, Muhltal (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: Merck Patent GmbH, Darmstadt (DE)

(21) Appl. No.: 10/073,303

(22) Filed: Feb. 13, 2002

(30) Foreign Application Priority Data
Feb. 13, 2001 (DE) 101 06 576.0

(51) Int. Cl. C08K 5/00

(52) U.S. Cl. 106/493

(57) ABSTRACT

The invention relates to pigment preparations for anticorrosion paints which are employed in primers for metallic objects, have a good corrosion-protection action and consist of from 1 to 99% by weight of one or more compounds which absorb OH⁻ ions and from 1 to 99% by weight of one or more compounds which catalyze an oxygen-reduction reaction on a metallic substrate.

The invention relates to lead- and chromate-free pigment preparations for anticorrosion paints.

Metallic objects are usually provided with corrosion protection by coating with a metallic, inorganic or organic protective coating. In particular, specific pigments and/or fillers are added to the organic protective coatings in order to improve their corrosion protection capability. Examples of pigments of this type are red lead, zinc chromate, zinc phosphate, talc, graphite and mica.

However, organic compounds can also be employed alone or in combination with inorganic pigments and fillers as anticorrosion pigments. Thus, for example, benzidine phosphate, benzidine molybdate, benzidine hexacyanoferrate, organic phosphonic and arsenious acids and aromatic and aliphatic carboxylic acids and salts thereof, such as, for example, benzoates and laurates, are employed as organic compounds for corrosion protection.

Lead and chromate pigments are distinguished by high efficacy, but can no longer be used for corrosion-protection purposes owing to their toxic and/or carcinogenic properties. In the past, they have often been replaced by zinc phosphate or zinc tetraborate, but these are only able to achieve a significantly lesser protective action.

Thus, the efficacy of zinc salts only arises when corrosion of the substrate to be protected has already taken place. If this substrate consists, for example, of iron, the following reaction occurs:

Fe→Fe²⁺+2e⁻

½O₂+H₂O+2e⁻→2OH⁻

The OH|⁻ ions produced thereby form basic, low-solubility complexes with the zinc salts which either adhere strongly to the substrate surface or are precipitated in defects of an anticorrosion primer and block these. In order to achieve this action, however, the zinc salts have to be present in a sufficiently high pigment volume concentration and have to be present locally at the defective point, i.e. must not already have been washed out in advance owing to their water solubility. In addition, other complex-forming species must not be present in the substrate or coating. Since these pre-requisites rarely exist in an optimum manner, the efficacy of zinc salts is significantly reduced compared with the classical active pigments red lead and zinc chromate or is not present at all.

DD 281 427 has described metal phthalocyanines as highly suitable anticorrosion pigments in protective paints on iron substrates. It is proposed that these be employed as pure pigment in combination with a conductive carrier.

DE 44 11 568 relates to an improved pigment composition which comprises a chelating compound, which may be a metal phthalocyanine, a platelet-shaped material, a hydroxyl ion-forming component and optionally a conductive pigment. However, it has been found that the platelet-shaped pigment causes increased porosity in the paint material, which results in the paint becoming permeable on contact with water, and the water is able to penetrate unhindered as far as the substrate, accelerating the corrosion.

DE 195 16 580 describes a pigment preparation which comprises a metal oxide-coated, platelet-shaped carrier material and an active pigment, where the active pigment may be either a compound which is capable of converting primary corrosion products into solid, water-stable compounds, or a chelating compound, for example a metal phthalocyanine. Although the problem of increased porosity of the paint owing to the platelet-shaped pigments has been solved here by the surface coating of these pigments with metal oxides, this surface modification is both expensive and time-consuming and is thus disadvantageous.

DE 197 21 645 discloses a preparation for anticorrosion paints which, besides a chelating compound, which may be a phthalocyanine, comprises a hydroxyl ion-binding material and a conductive pigment based on carbon. The aim of the use of conductive pigments was to influence the corrosion reaction as an electron reaction in such a way that accelerated formation of a passive layer takes place.

However, it is observed in recent customary binder systems, such as, for example, epoxy resins or acrylates, that corrosion cannot be controlled in a targeted manner in all cases by addition of conductive pigments and that the hoped-for corrosion protection does not arise in some cases, but instead accelerated corrosion occurs.

There was thus a continued demand for lead- and chromate-free pigment preparations which can be used in primers on corrosion-susceptible materials and whose efficacy is the same as the corrosion protection capability of lead and chromate pigments.

An object of the invention is thus to provide a pigment preparation which can be prepared simply and inexpensively and which can be incorporated into paint formulations based on conventional binders, exhibits a corrosion protection action which is comparable with lead and chromate pigments in protective paints on a wide variety of metal substrates, and produces low-pore, smooth and durable protective coats in the binder matrix.

These and other objects can be achieved in accordance with the present invention by a pigment preparation comprising

(i) 1-99% by weight of one or more compounds which absorb OH⁻ ions, and

(ii) 1-99% by weight of one or more compounds which catalyze an oxygen-reduction reaction on a metallic substrate.

In a preferred embodiment, the object of the patent is achieved by a pigment preparation comprising

(i) 1-99% by weight of one or more compounds which absorb OH⁻ ions, and

(ii) 1-99% by weight of a metal-free or metal-containing chelate compound of the general formula I or II

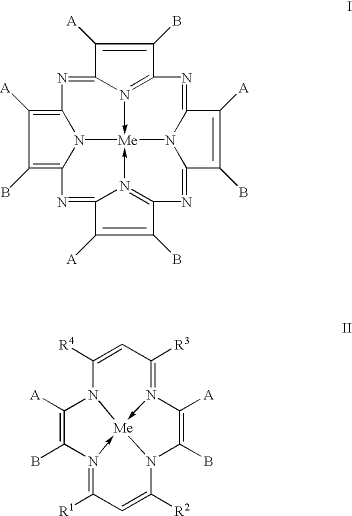

in which

A and B are each, independently of one another, an optionally substituted aromatic or cycloaliphatic radical, which may also contain heteroatoms, such as S, Se, O and N, such as in the ring and may also contain aryl, alkyl, halogen, oxygen-containing, sulfur-containing or nitrogen-containing groups as additional substituents,

R¹, R²,

R³ and R⁴ are H atoms or alkyl radicals, and

Me is Cu, Fe, Ni, Co, Mn, Bi, Sn, Zn or 2H.

Preferred substituents for A and B include aryl, such as phenyl and benzyl (optionally substituted by alkyl) and alkyl groups. Preferred compounds for nitrogen-containing groups include pyridine and pyrimidine, for sulfur-containing groups thiophenes and for oxygen-containing groups furans.

The compounds (i) which absorb, i.e., incorporate OH⁻ ions in the molecular lattice of said compounds, OH⁻ ions include various phosphates, meta-phosphates, bi- and triphosphates, silica gels, silicates, aluminum silicates, calcite and all low-solubility metal salts which form low-solubility basic salts and complex compounds with OH⁻ ions. For example, Ca[SiO₃] forms Ca₃(OH)₂[Si₄O₁₀] by incorporating hydroxyl ions.

However, it is also possible to use compounds which form, on their surface, a buffer system which sets the pH of the adjacent aqueous medium to the range 6≦pH≦8.5. In this pH range, delamination of organic coatings, for example on steel substrates, is not to be expected.

Preferred compounds which absorb OH⁻ ions are various phosphates, in particular those with the cations Mg, Ca, Sr, Ba, Zn and Al. Particular preference is given to calcium and zinc phosphates.

The compounds which absorb OH⁻ ions can be employed individually or in the form of a mixture of two or more compounds and are present in the pigment preparation according to the invention in a proportion of from 1to 99% by weight, preferably from 10 to 98% by weight, particularly preferably from 20 to 97% by weight.

The compounds (ii) which catalyze an oxygen-reduction reaction on a metallic substrate are, in particular, chelate compounds of the formula I or II, and also various thiospinels or various perovskites. These may be present in the pigment preparation according to the invention individually or in the form of a mixture of two or more compounds and are present in a proportion of from 1 to 99% by weight, preferably from 2 to 90% by weight, particularly preferably from 3 to 80% by weight.

The chelate compounds (ii) employed are the above-mentioned compounds characterised by the general formulae I and II, preferably phthalocyanines, tetraarylporphyrins and tetraazaannulenes. Of the phthalocyanines, metal phthalocyanines, such as iron phthalocyanine, cobalt phthalocyanine and nickel phthalocyanine, are preferred, with iron phthalocyanine being particularly preferred. Examples of tetraarylporphyrins are cobalt tetraphenylporphyrin, iron tetraphenylporphyrin and nickel tetraphenylporphyrin. Of the tetraazaannulenes, metal tetraazaannulenes, for example iron tetraazaannulene, nickel tetraazaannulene and cobalt tetraazaannulene, are preferred.

In the compounds of the formulae I and II, alkyl is a preferably straight-chain or branched alkyl having 1-18 carbon atoms, in which, in addition, one or more CH₂ groups has been replaced by —CO—, —O—, —S—, —COO— or —O—CO— in such a way that two —O— atoms are not adjacent to one another. Halogen is preferably bromine or chlorine.

Since the preparation of metal phthalocyanines causes high costs, it is likewise possible to apply this component to insoluble inorganic fillers which serve as carrier materials, enabling the amount of metal phthalocyanines to be restricted without reducing the corrosion-protection effect. These fillers can have any desired shapes, such as, for example, spherical, platelet-shaped or needle-shaped. The possible materials are, for example, BaSO₄, SiO₂, mica and other phyllosilicates, or the like.

The chelate compounds are present in the pigment preparation according to the invention in a proportion of from 1 to 99% by weight, preferably from 2 to 90% by weight, and particularly preferably from 3 to 80% by weight. They reduce oxygen, which, dissolved in water, penetrates in the coating via pores and layer defects as far as the substrate surface, with the metal substrate being passivated.

The reduction of the oxygen forms hydroxyl ions in accordance with the following equation:

O₂+2H₂O+4e⁻→4OH⁻.

These hydroxyl ions are bound by component (i) of the pigment preparation according to the invention by intercalation into the crystal lattice thereof. This binding of the OH⁻ ions to component (i) has the effect that delamination of the applied protective coating from the metal substrate can be prevented, so that sub-film corrosion (known as sub-film rusting in the case of iron materials) does not occur.

Investigations by the inventors of the present invention have shown that earlier pigment preparations for corrosion-protection purposes which comprised, for example, chelate compounds, a platelet-shaped material, a material which binds OH⁻ ions and optionally a conductive pigment did not result in the desired efficacy. Thus, it had been expected that platelet-shaped pigments which align in a preferential direction owing to their shape should form a barrier layer in the manner of roof shingle which should protect the metallic substrates coated with the protective coating against penetration of water into the latter. By contrast, however, it has been found that untreated platelet-shaped pigments in protective coatings of this type resulted in increased porosity of the coating, with the consequence that ingressing water was able to penetrate unhindered as far as the substrate surface. Corrosion of the substrate was thus not prevented, but, by contrast, accelerated.

Although it has been possible to solve this problem by expensive and time-consuming surface modification of the platelet-shaped pigments, this has not, however, proven economically acceptable.

Later attempts to employ a pigment preparation based on a chelate compound, an OH⁻ ion-forming material and a conductive pigment based on carbon resulted in the conductive pigments not, as expected, influencing the corrosion reaction in each case to such an extent that accelerated passive-layer formation commenced, but instead, in contrast, they only accelerated the reaction to the degree to which the corrosion proceeded to an increased extent, and no passive-layer formation occurred.

The inventors of the present invention have found, in investigations of the mode of action of these conductive pigments, that both the choice of binder and the type and number of further additives have a crucial influence on whether, for example in the case of an iron substrate, the oxidation rate of the iron atoms in the crystal structure is faster than the detachment of these atoms from the crystal, which would result in the formation of a protective top coat of iron oxide, or not. If an ideal mixture composition is not achieved, the hoped-for corrosion protection does not arise, but instead accelerated corrosion occurs. For this reason, pigment mixtures with conductive pigments have proven to be uncontrollable and thus impracticable, in particular for the commonest binder systems, such as epoxy resins or acrylates.

However, it was also known that both chelate compounds, such as, for example, iron phthalocyanine, alone and OH⁻ ion-forming compounds, such as, for example, zinc phosphate, alone were unable to achieve the desired efficacy as anticorrosion pigments.

It has therefore been found, surprisingly, that joint use of compounds which absorb OH⁻0 ions with compounds which catalyze an oxygen-reduction reaction on a metallic substrate results, without further addition of active ingredients, in an effective pigment preparation for anticorrosion paints which, in addition, can be varied in a broad range with respect to the proportions of the individual components and can thus be optimised for various applications. Since the number of pigment types is significantly reduced compared with the solutions known from the prior art, a smaller number of assistants which are needed for the preparation of a homogeneous anticorrosion paint is required. The burden on the system as such is thus reduced, and the number of interfering factors is decreased.

The pigment preparation according to the invention is prepared from the individual components in grinding fineness which is suitable for practice using the usual machines in the pigment and paints industry, such as sand or bead mills, ball mills, roll mills and air-jet mills and are dispersed in paint formulations based on conventional binders. The proportion of pigment preparation according to the invention is generally 3-35% by weight, based on the weight of the paint formulation as a whole. However, it is also possible for the individual components to be dispersed successively in the binder. Thus, for example, alkyd resins, epoxy resins, acrylates, polyurethanes, chlorinated rubber or melamine resins are generally employed in amounts of from 10 to 70% by weight, preferably from 35 to 55% by weight, as binders in paint formulations for corrosion protection.

If, on use of metal phthalocyanines in the pigment formulations according to the invention, they are applied to an inorganic filler as carrier material, this can be carried out by generally known methods. Thus, for example, iron phthalocyanine is either precipitated onto an inorganic carrier from a solution in concentrated sulfuric acid or applied to an inorganic carrier by joint grinding. Even the synthesis of metal phthalocyanines from the starting materials by conventional synthetic methods with addition of a carrier material results in pigments coated with metal phthalocyanines. The pigment is subsequently introduced into the binder system with the aid of dispersion methods. It is also possible that other chelate compounds may be carried on an inorganic filler. This is accomplishable by synthesis of, for example, porphyrenes or annulenes in the presence of the inorganic filler or by dissolving the porphyrenes or annulenes in a suitable solvent, e.g., sulphuric acid or DMF, and precipitating at the surface of the inorganic filler.

The paint formulation may furthermore comprise any assistants and fillers. These are, in particular, the conventional desiccants, dispersion media, flow-control agents, antisettling agents, adhesives or agents for setting a certain thixotropy. In addition, solvents may likewise be present in the formulation in a proportion of from about 10 to 70% by weight, preferably from 10 to 20% by weight. It is necessary here for the solvent to be matched technically to the respective binder. Customary solvents are butyl acetate, xylene and paraffin hydrocarbon mixtures having a boiling range of from 120 to 180° C.

The pigment preparation in accordance with the present invention is employed for anticorrosion paints which are applied as primer to a wide variety of metal substrates, in particular to the surfaces of iron materials. A primer of this type is distinguished, after completion of the film formation, by pronounced corrosion-protection properties on exposure to the atmosphere or to aerated aqueous media.

All requirements usually made of the corrosion-protection properties of pigments can be met by the pigment preparation according to the invention. Thus, neither the flow-out properties nor the film-formation properties of the paint are impaired; indeed, a particularly uniform, aging-resistant layer which adheres strongly to metal substrates and has an unforeseeable barrier action can be achieved, in particular due to the greatly restricted variety of pigments compared with the prior art.

The overcoatability of the resultant primer for building up multicoat systems is in no way restricted by the pigment preparation according to the invention. Pores, or coating defects arising due to mechanical influences can be passivated by the action of atmospheric moisture or aqueous media, preventing sub-film corrosion.

The pigment preparations according to the invention can be employed in paint formulations which comprise zinc phosphate without the disadvantages in the corrosion-protection action which are otherwise associated therewith, and can be prepared inexpensively in a simple manner.

Due to the addition of compounds which catalyze an oxygen-reduction reaction on a metallic substrate, the conventional paints comprising zinc phosphate can be improved qualitatively in such a way that an early and increased corrosion-protection action is achieved which is comparable with that of primers comprising red lead or chromate pigments.

The invention will be explained with reference to the following examples without being restricted thereto.

### EXAMPLES

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever.

In the foregoing and in the following examples, all temperatures are set forth uncorrected in degrees Celsius; and, unless otherwise indicated, all parts and percentages are by weight.

The entire disclosures of all applications, patents and publications, cited above or below, and of corresponding German application No. 10106576.0, filed Feb. 13, 2001, is hereby incorporated by reference.

### Example 1

80 g of iron phthalocyanine (FePc) and 20 g of zinc phosphate are ground intensively for about 30 minutes in an air-jet mill. The resultant pigment is added in a concentration of 15% by volume as anticorrosion pigment to a conventional epoxy resin-based coating material which, besides the binder, also comprises further conventional additives and solvents, which corresponds to a standard commercial formulation. The coating material obtained in this way is applied to 3 metal samples in a standard coating thickness of 50 μm. The samples are subjected to the following corrosion-protection tests: salt-spray test, KESTERNICH test, VDA test, cathodic polarisation, MACHU test and accelerated outdoor weathering. The results are given in Table 1 and show a corrosion-protection action which is comparable with zinc chromate.

### Example 2

10 g of FePc and 90 g of zinc phosphate are ground intensively for about 30 minutes in an air-jet mill. The resultant pigment is added in a concentration of 15% by volume as anticorrosion pigment to a conventional epoxy resin-based coating material in accordance with Example 1. The coating material obtained in this way is applied to 3 metal samples in a standard coating thickness of 50 μm. The samples are subjected to the following corrosion-protection tests: salt-spray test, KESTERNICH test, VDA test, cathodic polarisation, MACHU test and accelerated outdoor weathering. The results are given in Table 1 and show a significant increase in corrosion protection compared with zinc phosphate.

### Example 3

50 g of nickel phthalocyanine (NiPc) and 50 g of calcium phosphate are ground intensively for about 30 minutes in an air-jet mill. The resultant pigment is added in a concentration of 15% by volume as anticorrosion pigment to a conventional epoxy resin-based coating material in accordance with Example 1. The coating material obtained in this way is applied to 3 metal samples in a standard coating thickness of 50 μm. The samples are subjected to the following corrosion-protection tests: salt-spray test, KESTERNICH test, VDA test, cathodic polarisation, MACHU test and accelerated outdoor weathering. The results are given in Table 1 and show a corrosion-protection action which is comparable with zinc chromate.

### Example 4

20 g of cobalt tetraphenylporphyrin (COTPP) and 80 g of zinc phosphate are ground intensively for about 30 minutes in an air-jet mill. The resultant pigment is added in a concentration of 15% by volume as anticorrosion pigment to a conventional epoxy resin-based coating material in accordance with Example 1. The coating material obtained in this way is applied to 3 metal samples in a standard coating thickness of 50 μm. The samples are subjected to the following corrosion-protection tests: salt-spray test, KESTERNICH test, VDA test, cathodic polarisation, MACHU test and accelerated outdoor weathering. The results are given in Table 1. They show a corrosion-protection action which is significantly improved compared with the use of zinc phosphate.

### Example 5

10 g of FePc and 90 g of aluminum phosphate are ground intensively for about 30 minutes in an air-jet mill. The resultant pigment is added in a concentration of 15% by volume as anticorrosion pigment to a conventional epoxy resin-based coating material in accordance with Example 1. The coating material obtained in this way is applied to 3 metal samples in a standard coating thickness of 50 μm. The samples are subjected to the following corrosion-protection tests: salt-spray test, KESTERNICH test, VDA test, cathodic polarisation, MACHU test and accelerated outdoor weathering. The results are given in Table 1 and show a corrosion-protection action which is significantly improved compared with that of zinc phosphate.

### Comparative Example 1

40 g of FePc, 20 g of zinc phosphate, 20 g of mica (N fraction, Merck) and 20 g of Minatec® 31 CM (conductive mica pigment from Merck) are ground intensively for about 30 minutes in an air-jet mill. The resultant pigment is added in a concentration of 15% by volume as anticorrosion pigment to a conventional epoxy resin-based coating material in accordance with Example 1. The coating material obtained in this way is applied to 3 metal samples in a standard coating thickness of 50 μm. The samples are subjected to the following corrosion-protection tests: salt-spray test, KESTERNICH test, VDA test, cathodic polarisation, MACHU test and accelerated outdoor weathering. The results are given in Table 2

### Comparative Example 2

60 g of FePc, 20 g of zinc phosphate and 20 g of mica (N fraction, Merck) are ground intensively for about 30 minutes in an air-jet mill. The resultant pigment is added in a concentration of 15% by volume as anticorrosion pigment to a conventional epoxy resin-based coating material in accordance with Example 1. The coating material obtained in this way is applied to 3 metal samples in a standard coating thickness of 50 μm. The samples are subjected to the following corrosion-protection tests: salt-spray test, KESTERNICH test, VDA test, cathodic polarisation, MACHU test and accelerated outdoor weathering. The results are given in Table 2.

### Comparative Example 3

100 g of zinc phosphate (ZDP-A, Heubach) are ground intensively for about 30 minutes in an air-jet mill. The resultant pigment is added in a concentration of 15% by volume as anticorrosion pigment to a conventional epoxy resin-based coating material in accordance with Example 1. The coating material obtained in this way is applied to 3 metal samples in a standard coating thickness of 50 μm. The samples are subjected to the following corrosion-protection tests: salt-spray test, KESTERNICH test, VDA test, cathodic polarisation, MACHU test and accelerated outdoor weathering. The results are given in Table 2.

### Comparative Example 4

100 g of zinc chromate are ground intensively for about 30 minutes in an air-jet mill. The resultant pigment is added in a concentration of 15% by volume as anticorrosion pigment to a conventional epoxy resin-based coating material in accordance with Example 1. The coating material obtained in this way is applied to 3 metal samples in a standard coating thickness of 50 μm. The samples are subjected to the following corrosion-protection tests: salt-spray test, KESTERNICH test, VDA test, cathodic polarisation, MACHU test and accelerated outdoor weathering. The results are given in Table 2.

TABLE 1

| | | | | | Ex- |
|---|---|---|---|---|---|
| Test/Example | Example 1 | Example 2 | Example 3 | Example 4 | ample 5 |
| Salt-spray test | 77 | 72 | 71 | 64 | 71 |
| KESTERNICH | 84 | 77 | 79 | 71 | 81 |
| test | | | | | |
| VDA test | 74 | 72 | 66 | 59 | 72 |
| Cathodic | 76 | 71 | 69 | 61 | 72 |
| polarisation | | | | | |
| MACHU test | 69 | 70 | 62 | 59 | 68 |
| Accelerated | 87 | 80 | 82 | 73 | 84 |
| outdoor | | | | | |
| weathering | | | | | |

The numerical values in Tables 1 and 2 correspond to the corrosion protection value (CPV) and denote:

no change in the coating→CPV =100

total destruction of the coating→CPV=0

TABLE 2

| Test/ | | | | |
|---|---|---|---|---|
| Comparative | Comparative | Comparative | Comparative | Comparative |
| Example | Example 1 | Example 2 | Example 3 | Example 4 |
| Salt-spray test | 45 | 64 | 59 | 63 |
| KESTERNICH | 55 | 68 | 57 | 69 |
| test | | | | |
| VDA test | 52 | 62 | 60 | 75 |
| Cathodic | 47 | 56 | 53 | 72 |
| polarisation | | | | |
| MACHU test | 39 | 59 | 51 | 62 |
| Accelerated | 67 | 72 | 68 | 88 |
| outdoor | | | | |
| weathering | | | | |

The tests mentioned in Tables 1 and 2 are carried out as follows:

Salt-Spray Test: in Accordance with DIN 53167

A solution of 50 g of NaCI per liter of distilled water having a pH of 6.6 is sprayed at a temperature of 35° C. onto coated samples which are inclined in the plane about 20° to the vertical. A cycle is used in which alternately salt mist is sprayed for 45 minutes and no salt mist is sprayed for 15 minutes. The test lasts 10 weeks.

KESTERNICH Test: in Accordance with ISO 6988/DIN 50018

The samples are prepared by applying the formulation mentioned in the examples to steel foils measuring 300 mm×20 mm×0.5 mm in a coating thickness of 50 μm. The metal samples are provided with electrical contacts and introduced into a test chamber. In the test chamber, SO₂ is liberated, and the sample is exposed thereto in a number of cycles. The corrosion protection value is determined by visual observation.

VDA test: Alternating climate test in accordance with VDA 621-415 The coated samples are subjected to a test which comprises different climatic conditions in a 7-day cycle:

| | |
|---|---|
| 1 day (24 hours): | spraying of a salt solution in accordance with DIN |
| | 53167 (see above) |
| 4 days: | 4 cycles condensation water - alternating climate |
| | KFW in accordance with DIN 50017 |
| 2 days (48 hours): | in air at room temperature |

The test runs over 9 cycles.

Cathodic Polarisation:

Test for assessment of delamination. A scratch with a length of 3 cm is made on the coated samples (Clemen scratch apparatus). The scratch is subjected to a current strength of 1 mA for 4 hours via an attachment measuring cell containing 0.5 M Na₂SO₄ solution (3.5 cm, aerated). The degree of delamination of the applied coating is assessed.

MACHU Test

Alternating exposure after immersion for 8 hours in a solution of 50 g of NaCI, 10 ml of glacial acetic acid, 5 g of 30% hydrogen peroxide solution per liter of distilled water (fresh daily) at 40° C. and exposure for 16 hours in dry air at room temperature in each cycle. 2 cycles are carried out.

Accelerated outdoor weathering: in accordance with DIN 53166 The samples are stored outdoors for a period of 6 months and in addition moistened weekly with a 3% NaCI solution.

The preceding examples can be repeated with similar success by substituting the generically or specifically described reactants and/or operating conditions of this invention for those used in the preceding examples.

The entire disclosures of all applications, patents and publications, cited above or below, and of corresponding German application number 10106576.0 filed Feb. 13, 2001, is hereby incorporated by reference.

From the foregoing description, one skilled in the art can easily ascertain the essential characteristics of this invention and, without departing from the spirit and scope thereof, can make various changes and modifications of the invention to adapt it to various usages and conditions.

1. A pigment composition comprising:
1-99% by weight of one or more compounds which absorb OH⁻ ions, and
1-99% by weight of one or more compounds which catalyze an oxygen-reduction reaction on a metallic substrate.

2. A pigment composition according to claim 1, comprising a metal-free or metal-containing chelate compound of formula I or II as the one or more compounds which catalyze an oxygen-reduction reaction on a metallic substrate 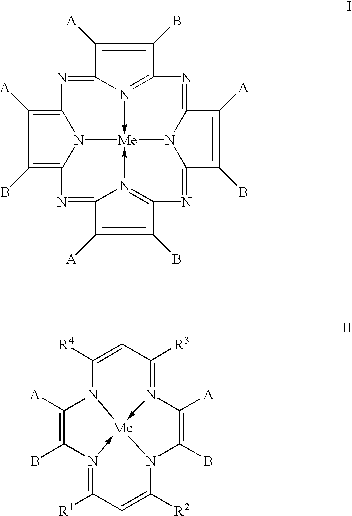
in which
A and B are each, independently, an optionally-substituted aromatic or a cycloaliphatic radical, which optionally comprises one or more heteroatoms, comprising S, Se, O or N, and which is optionally substituted by one or more aryl, alkyl, halogen, oxygen-containing, sulfur-containing or nitrogen-containing groups,
R¹, R²,
R³ and R⁴ are each, independently, H or an alkyl radical, and
Me is Cu, Fe, Ni, Co, Mn, Bi, Sn, Zn or 2H.

3. A pigment composition according to claim 1, in which the one or more compounds which absorb OH⁻ ions comprise a phosphate, a metaphosphate, a bi- or triphosphate, a silica gel, a silicate, an aluminosilicate, a calcite, a low-solubility metal salt, or a mixture thereof.

4. A pigment composition according to claim 3, in which the one or more compounds which absorb OH⁻ ions comprise a phosphate comprising a Mg, Ca, Sr, Ba, Zn or Al cation, or a mixture thereof.

5. A pigment composition according to claim 4, in which the one or more compounds which absorb OH⁻ ions comprises a zinc phosphate.

6. A pigment composition according to claim 4, in which the one or more compounds which absorb OH⁻ ions comprises a calcium phosphate.

7. A pigment composition according to claim 1, in which the one or more compounds which catalyze an oxygen-reduction reaction on a metallic substrate comprise a thiospinel or a perovskite, or a mixture thereof.

8. A pigment composition according to claim 2, in which the chelate compound comprises a phthalocyanine, a tetraarylporphyrin, a tetraazaannulene, or a mixture thereof.

9. A pigment composition according to claim 8, in which the chelate compound is a metal phthalocyanine, a metal tetraarylporphyrin, a metal tetraazaannulene, or a mixture thereof.

10. A pigment composition according to claim 9, in which the chelate compound is an iron phthalocyanine, a cobalt phthalocyanine, a nickel phthalocyanine or a mixture thereof.

11. A pigment composition according to claim 9, in which the chelate compound is a cobalt tetraphenylporphyrin, an iron tetraphenylporphyrin, a nickel tetraphenylporphyrin, or a mixture thereof.

12. A pigment composition according to claim 9, in which the chelate compound is an iron tetraazaannulene, a nickel tetraazaannulene, a cobalt tetraazaannulene or a mixture thereof.

13. A pigment composition according to claim 9, in which the chelate compound is iron phthalocyanine.

14. A pigment composition according to claim 1, comprising 10 to 98% by weight one or more compounds which absorb OH⁻ ions, and 2 to 90% by weight one or more compounds which catalyze an oxygen-reduction reaction on a metallic substrate.

15. A pigment composition according to claim 1, which is essentially free of lead and chromate.

16. A pigment composition according to claim 1, comprising 20 to 97% by weight one or more compounds which absorb OH⁻ ions, and 3 to 80% by weight one or more compounds which catalyze an oxygen-reduction reaction on a metallic substrate.

17. A pigment composition according to claim 2, wherein each alkyl, independently, is straight-chain or branched and has 1-18 carbon atoms in which, optionally, one or more CH₂ groups is replaced by —CO—, —O—, —S—, —COO—or —O—CO— in such a way that two —O— atoms are not adjacent.

18. A pigment composition according to claim 2, wherein the halogen is bromine or chlorine.

19. A pigment composition according to claim 9, wherein the chelate compound is carried on an inorganic filler.

20. A pigment composition according to claim 19, wherein the filler is BaSO₄, SiO₂, mica or another phyllosilicate.

21. A pigment composition according to claim 1, which is free of additional active ingredients.

22. A coating composition, an anticorrosion paint or an anticorrosion primer comprising a pigment composition according to claim 1.

23. A coating composition, an anticorrosion paint or an anticorrosion primer comprising 3-35% by weight a pigment composition according to claim 1.

24. A coating composition, an anticorrosion paint or an anticorrosion primer comprising one or more compounds which absorb OH⁻ ions and one or more compounds which catalyse an oxygen-reduction reaction on a metallic substrate.

25. A pigment composition according to claim 2, wherein A and B are each, independently, an aryl- or alkyl-group and wherein the oxygen-containing group is a furane, the sulfur-containing group is a thiophene and the nitrogen-containing group is a pyridine or a pyrimidine.
